(19) United States
(12) Patent Application Publication
(10) Pub. No.: US 2003/0203138 A1
(43) Pub. Date: Oct. 30, 2003

(54) Article with protected printing and method of manufacture

(76) Inventor: James E. Gargus, Prosper, TX (US)

Correspondence Address: Monty L. Ross, Locke Liddell & Sapp LLP, Suite 2200, 2200 Ross Avenue, Dallas, TX, 75201-6776, US

(21) Appl. No.: 10/135,601

(22) Filed: Apr. 29, 2002

(51) Int. Cl. B32B 1/02

(52) U.S. Cl. 428/34.2; 428/203

(57) ABSTRACT

Manufactured articles are disclosed having graphics that are reverse-printed onto a surface of a transparent polymeric sheet or web that is subsequently adhesively attached to a substrate with the reverse-printed surface placed in facing engagement with the substrate so that the graphics are clearly viewable and readable in a non-reverse format to an observer viewing the substrate. The substrate can be any material useful in the production of signage, packaging or other products, provided that the reverse-printed surface of the polymeric sheet or web can be adhesively attached to the substrate.

### BACKGROUND OF THE INVENTION

1. Field of the Invention

This invention relates to manufactured articles such as signs, containers, boxes, cartons and receptacles having outwardly facing surfaces bearing graphics including text and/or designs and, more particularly, to articles having graphics that are printed and applied to such surfaces in a way that significantly reduces flaking, scratching or other damage to the graphics during use or exposure to weather or wear.

2. Description of Related Art

The use of various printing processes and technologies to apply graphics directly to surfaces of paper, card stock, corrugated board, fiberboard, and the like, is well known. Where the printed materials are used for making three dimensional articles such as containers or cartons, such printing is frequently applied to flat sheets or webs of a substrate material prior to die cutting, folding and assembly of the material into a finished article. Where gloss or water resistance are important, the printed surface also can be coated with a polymeric coating prior to die cutting, folding and/or assembly.

It is also well known to print graphics directly onto paper or plastic webs or sheets, which are subsequently cut to desired size and applied as labels to a substrate material using a suitable adhesive. The adhesive can be a pressure sensitive adhesive applied, for example, to the back of a printed sheet, or can be applied to a substrate as a separate layer prior to contacting it with a printed sheet.

More recently, U.S. Pat. No. 6,076,332 has disclosed a method for making weather resistant packaging with high quality graphics on the exterior of packaging material wherein the desired graphics are printed on the outwardly facing surface of a thin vinyl sheet with an offset lithographic printing process using solventless, styrene-based, ultraviolet ink on the vinyl substrate. Optionally, a water-based coating can be applied over the cured ink to increase wear resistant attributes of the desired graphics. The vinyl sheet is attached to the packaging material, and an ultraviolet clear coat is placed over the combined vinyl sheet and packaging material. Finally, the combination is cut to form the weather resistant package having the desired graphics.

Notwithstanding the improvements previously made in printing graphics onto materials used in making various types of packaging, problems are still encountered that are directly attributable to weathering, peeling, flaking, scratching or other abrasion of the printed text or images.

### SUMMARY OF THE INVENTION

Articles such as printed signage and packaging materials, and a method for making them, are disclosed herein. The present invention overcomes many of the disadvantages previously experienced in using prior art methods and materials. According to one embodiment of the invention, graphics are printed onto the reverse side of transparent polymeric sheet material that is then adhesively applied to an underlying substrate. When the reverse-printed sheets are intended for use with boxes, cartons, receptacles or other packaging, they are preferably applied to a substrate prior to die cutting, folding and assembly.

One preferred use of the present invention is for making fiberboard boxes used in packaging tools such as drill bits for oil and gas wells. According to this preferred embodiment of the invention, boxes having hard fiberboard sides with some exterior surfaces bearing printed graphics are made by reverse-printing the graphics onto the back side of a transparent polymeric sheet material and then laminating the sheet material onto a fiberboard substrate in such manner that the graphics are sandwiched between the polymeric sheet and substrate. The graphics are desirably laminated onto the substrate at positions corresponding to panels or wall sections that are externally visible in the finished box. Boxes formed from substrates made in this manner embody printed graphics that are clearly visible, yet are protected by the polymeric sheet from flaking, scratching or other damage during use or exposure to weather or wear. Unlike packages made using prior art methods, the graphics are protected without the need for additional external polymeric layers or coatings to protect the printing. The thickness of the transparent polymeric sheet material used in the present invention is typically greater than that which can be applied as a surface coating, and the sheet thickness is easily varied, depending upon the intended application. Furthermore, the present invention is easily adaptable for use in making other products.

According to another preferred embodiment of the invention, manufactured articles are disclosed having graphics that are reverse-printed onto a surface of a transparent polymeric sheet or web that is subsequently adhesively attached to a substrate with the reverse-printed surface placed in facing engagement with the substrate so that the graphics are clearly viewable and readable in a non-reverse format to an observer viewing the substrate. The substrate can be any material useful in the production of signage, packaging or other products, provided that the reverse-printed surface of the polymeric sheet or web can be adhesively attached to the substrate.

The method of the invention can be practiced using any conventional printing technique that is suitable for use with the film and substrate of choice, such as, for example, offset, screen, flexographic or digital printing. The subject method most preferably comprises the steps of providing a transparent, flexible polymeric sheet; applying graphics to the back side of the sheet so as to be plainly viewable through the front side; coating at least a portion of the back side of the sheet with a layer of adhesive; attaching the back side of the sheet to a substrate; and sizing and shaping the substrate into a desired article having the graphics viewable by an observer. If desired, one or more rollers can be used to press the reverse printed sheet into adhesive engagement with the substrate. Both the sheet and the substrate can be sized prior to or following attachment to each other, depending upon the article being made.

### BRIEF DESCRIPTION OF THE DRAWINGS

The apparatus of the invention is further described and explained in relation to the following figures of the drawings wherein:

FIG. 1 is a perspective view of a transparent polymeric sheet bearing graphics that are reverse-printed on one surface;

FIG. 2 is a perspective view of the printed sheet of FIG. 1 that has been rotated and laminated onto a fiberboard substrate with an adhesive layer disposed between the web and substrate;

FIG. 3 is a cross-sectional view taken along line 3-3 of FIG. 2;

FIG. 4 is a plan view of a substrate that has been die cut and scored into a shape suitable for use in forming a box, with four polymeric sheets bearing reverse printed graphics laminated onto the substrate in positions corresponding to the four side panels of a box, with the graphics oriented so as to be readable by an observer of the finished box;

FIG. 5 is a perspective view of a box assembled from the die cut and scored substrate of FIG. 4, with the sheets bearing the reverse-printed graphics being adhered to and plainly visible on the exterior panels of the box;

FIG. 6 is an exploded perspective view showing a rectangular plastic sheet having graphics (including lettering inside a rectangle) reverse printed on the bottom surface of the sheet, the sheet being disposed above a rectangular fiberboard substrate prior to attachment of the sheet to the substrate, with the outline of a box to be die-cut from the substrate shown in dashed outline, the placement and orientation of the graphics on the sheet corresponding to the placement and orientation of panels that will become the outside walls of the box;

FIG. 7 is a detail view of a corner broken away from a section of the fiberboard substrate having a corner of the plastic sheet turned up to show a layer of adhesive disposed on the underside of the sheet; and

FIG. 8 is a perspective view of a rectangular sign comprising a substantially rigid substrate having a transparent plastic film or sheet adhered to it, the film or sheet having graphics reverse printed on the surface facing the substrate.

Like reference numerals are used to indicate like parts in all figures of the drawings.

### DESCRIPTION OF THE PREFERRED EMBODIMENTS

The products of the invention preferably comprise signage, boxes, receptacles, containers, or the like, embodying graphics that are reverse printed onto the back side of transparent plastic film or sheet material, which reverse printed side is then attached by an adhesive to a flat or curvilinear surface of a substrate so that the graphics are plainly visible to an observer. As used in herein, “graphics” can include one or more of various graphical elements such as, for example, text, logos, geometric shapes, photographs, illustrations or other images, or combinations thereof, together with any opaque material applied, for example, as flood white or spot white to the back side of the transparent plastic film or sheet.

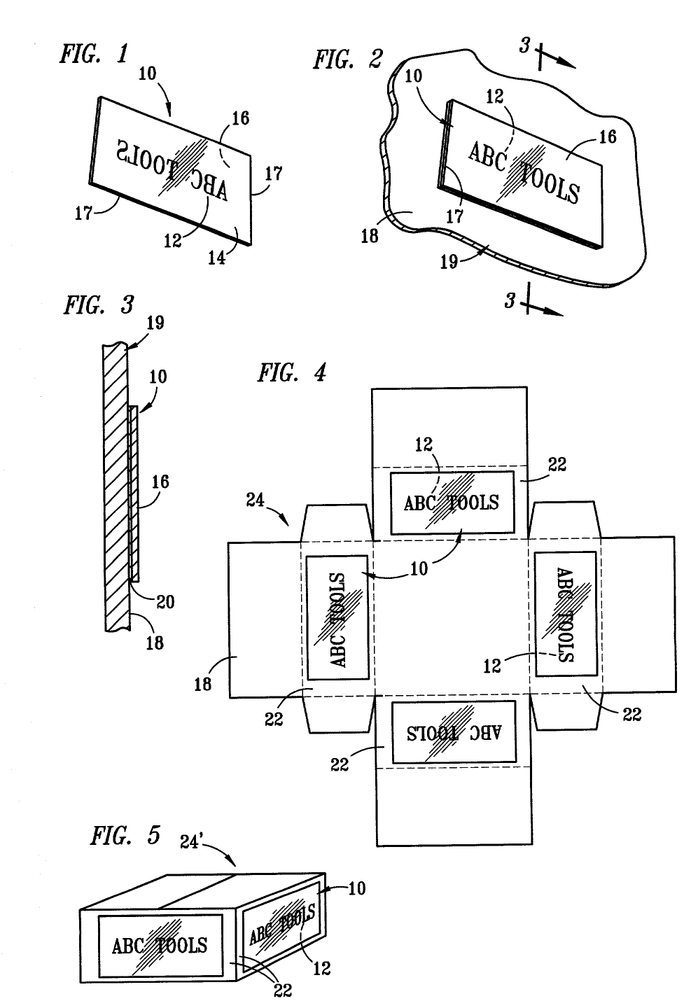

Referring to FIG. 1, sheet 10 is preferably a transparent polymeric film or sheet made from a material comprising, for example, polymers of vinyl, polyester, polyurethane, polycarbonate (Lexan®) or any other similarly effective transparent polymeric material. It will be appreciated that other commonly used additives such as UV stabilizers and the like can also be present in the material used to make sheet 10 so long as such additives do not detract appreciably from the transparent optical properties of the sheet. The transparent polymeric material can be provided as a continuous web, or in roll or sheet form, with a thickness ranging from about 3 to about 10 mils, and most preferably from about 5 to about 7 mils. The desired thickness of sheet 10 can vary, depending upon the particular type of polymeric material, printing ink, adhesive system and substrate utilized in making the subject articles, the intended use and the use environment. Sheet 10 preferably comprises back, or reverse, surface 14 and front, or obverse, surface 16, and peripheral edges 17.

Graphics 12 are preferably reverse printed onto back surface 14 of sheet 10 so as to be visible through transparent sheet 10 following attachment to a substrate as discussed below. Graphics 12 can be single or multi-color, with or without an opaque backing, and are reverse printed on back surface 14 of sheet 10 using any printing technology and any ink or other colorant suitable for printing onto a polymeric film or sheet material of the type selected for use in the invention. Such printing technologies can include, for example, offset, screen, flexographic or digital printing. Graphics 12 are desirably reverse printed onto back surface 14 of sheet 10 in a position or positions that will correspond to the visible surfaces of the desired completed article following attachment of sheet 10 to a substrate.

Referring to FIGS. 2 and 3, after graphics 12 are reverse printed onto back surface 14 of sheet 10 and cured or dried sufficiently to prevent smearing, back surface 14 of sheet 10 is preferably oriented in such manner that back surface 14 can be placed into facing and contacting engagement with front, or obverse, surface 18 of substrate 19. Substrate 19 is preferably selected from any sturdy sheet material to which web 10 can be attached or laminated using an adhesive 20 or other similarly effective means. Substrate 19 is preferably selected from fiberboard, medium density fiberboard (“MDF”), corrugated board, hardboard (e.g., Masonite® construction board, composite board), wood, polymeric sheet material having substantially greater thickness and rigidity than transparent sheet 10 (e.g., SINTRA® polyvinyl chloride sheet), or another similarly effective material that can later be die cut, folded and assembled if necessary to produce a sign, box, receptacle, container or other article.

Sheet 10 can be attached to substrate 19 by any suitable adhesive means. Adhesives preferred for use in the invention are those that will stick the sheet securely to the substrate, will not delaminate under expected use conditions, and will not chemically degrade or otherwise adversely affect the ink, transparent polymeric sheet or substrate. A particularly preferred adhesive 20 for use in attaching sheet 10 to substrate 19 is a resin based liquid adhesive that is rolled or otherwise coated onto back surface 14 of sheet 10 prior to contacting back surface 14 of sheet 10 against front surface 18 of substrate 19. This is conveniently done by passing back surface 14 of sheet 10 over a rotating cylindrical roll wetted with adhesive 20. Once sheet 10 is placed on substrate 19 with adhesive 20 between them, front surface 18 of sheet 10 is preferably pressed or rolled to promote bonding between the sheet and substrate. While adhesive 20 is preferably applied as a substantially continuous layer to back surface 14 of sheet 10, it will be understood by those of skill in the art upon reading this disclosure that adhesive 20 can instead be applied to surface 18 of substrate 19 or can be applied in spots or strips rather than in a continuous layer. Similarly, reverse printed sheets 10 having back surfaces 14 coated with pressure-sensitive adhesive covered by release paper can be produced in advance and stored pending use if desired.

Referring to FIGS. 4 and 5, sheet 10 is preferably attached to front surface 18 of the substrate in such manner that graphics 12 are clearly visible and properly positioned when substrate 19 is die cut to a desired shape and size as exemplified by box blank 24 to which graphics 12 are attached in positions corresponding to wall panels 22 when blank 24 is folded and assembled to form an article such as the finished box 24′ as seen in FIG. 5. The placement of individual sheets 10 bearing printed graphics 12 on particular panels 22 is sometimes referred to as “spot labeling.”

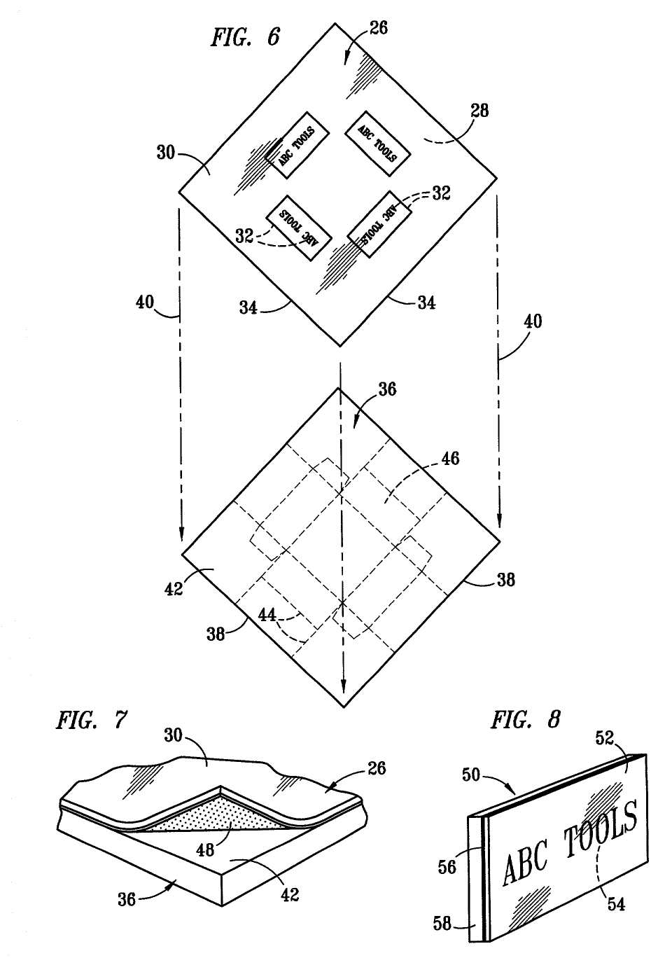

FIGS. 6 and 7 disclose another preferred embodiment of the invention wherein flexible, transparent polymeric sheet 26 made of a material as described above and comprising back surface 28 and front surface 30 has edges 34 that are substantially coextensive with edges 38 of substrate 36, also as previously described. This embodiment of the invention is particularly useful where a substantial portion of substrate 36 is intended to be covered by sheet 26 and where graphics 32 are to be placed in multiple positions on the finished article. Graphics 32, comprising both lettering and a rectangular border in this illustrative embodiment, are reverse printed onto back surface 28 of sheet 26, after which back surface 28 is coated with adhesive and sheet 26 is applied onto facing surface 42 of substrate 36 in the alignment indicated by arrows 40. It should be understood that an opaque background color can also be printed onto back surface 28 of sheet 26 if desired to provide contrast with graphics 32, to hide the natural appearance or color of front surface 18 of substrate 24 when viewed through transparent sheet 26, or for other aesthetic or functional reasons. Optionally, an opaque background can be printed as spot white over the text, logos, images, etc., that are reverse printed onto back surface 28 or can be printed as flood white over and around them on back surface 28 if desired. Additionally, if desired, an opaque barrier material can be applied or laminated to back surface 28. As shown in FIG. 6, substrate 36 is intended for use in producing a box that is to have its outwardly facing surfaces substantially covered by transparent polymeric sheet 26. Dashed lines 44 indicate where substrate 36 and sheet 26 will be cut or scored after sheet 26 is adhesively bonded to facing surface 42. FIG. 7 is a detail view of one corner of the assembled sheet 26 and substrate 36 of FIG. 6, except that a portion of sheet 26 is upturned to show adhesive layer 48 disposed between sheet 26 and surface 42 of substrate 36. Although the reverse printing (seen from above in readable form through sheet 26 in FIG. 6) is not visible in FIG. 7, it will be appreciated that the reverse printing is disposed between the back surface of sheet 26 and adhesive layer 48.

FIG. 8 discloses a sign 50 made in accordance with the invention in which graphics 54 are reverse printed on the back surface of transparent polymeric sheet 52 as previously described. After graphics 54 are reverse printed, sheet 52 is desirably bonded by adhesive 56 onto substrate 58 to form the finished sign 52. When articles such as box 24′, previously described, and sign 50 are made in accordance with the present invention, graphics 12, 54 are plainly visible to an observer but are protected from flaking, scratching or other damage to the graphics during use or exposure to weather or wear because graphics 12, 54 are disposed between the polymeric outer layer and the substrate to which it is attached.

Other alterations and modifications of the invention will likewise become apparent to those of ordinary skill in the art upon reading the present disclosure, and it is intended that the scope of the invention disclosed herein be limited only by the broadest interpretation of the appended claims to which the inventor is legally entitled.

1. An article comprising an outside wall comprising:
a transparent polymeric sheet having a back surface;
graphics reverse printed on the back surface;
a substrate having a front surface;
the back surface being attached in facing engagement to the front surface so that the graphics are disposed between the sheet and the substrate and are visible through the sheet.

2. The article of claim 1 wherein the substrate comprises a material selected from the group consisting of fiberboard, medium density fiberboard (“MDF”), corrugated board, hardboard, construction board, composite board, wood, and polymeric sheet having substantially greater thickness and rigidity than said transparent polymeric sheet.

3. The article of claim 2 wherein the substrate comprises fiberboard.

4. The article of claim 2 wherein the substrate comprises polyvinyl chloride sheet.

5. The article of claim 1 wherein the substrate is foldable.

6. The article of claim 1 wherein the transparent polymeric sheet comprises a polymer selected from the group consisting of vinyl, polyester, polyurethane and polycarbonate polymers.

7. The article of claim 1 wherein the transparent polymeric sheet has a thickness ranging from about 3 to about 10 mils.

8. The article of claim 7 wherein the transparent polymeric sheet has a thickness ranging from about 5 to about 7 mils.

9. The article of claim 1 wherein an adhesive is disposed between the back surface and the front surface.

10. The article of claim 9 wherein the adhesive is a resin based liquid adhesive.

11. The article of claim 9 wherein the adhesive is a substantially continuous layer applied to the back surface prior to attaching the sheet to the substrate.

12. The article of claim 1 wherein the sheet and substrate have edges that are substantially coextensive.

13. The article of claim 1 wherein the sheet and substrate are die cut.

14. The article of claim 1 wherein the sheet and substrate are scored.

15. The article of claim 1 wherein the article is a box.

16. The article of claim 15 wherein the article is a bit box.

17. The article of claim 1 wherein the article is a sign.

18. The article of claim 1 wherein the reverse printed graphics comprise at least one element selected from a group of graphical elements consisting of text, logos, geometric shapes, photographs, illustrations or other images, or combinations thereof.

19. The article of claim 18 wherein the reverse printed graphics further comprise an opaque material applied as at least one of flood white or spot white to the back side of the transparent plastic film or sheet.

20. A method for making an article comprising a substrate with an outwardly facing wall surface, a substantially transparent polymeric sheet attached to the wall surface, and graphics reverse printed on a reverse surface of the sheet between the sheet and wall surface, the method comprising the steps of:
providing a transparent polymeric sheet having a reverse surface;
reverse printing graphics on the reverse surface of the sheet;
providing a substrate having a desired size and an outwardly facing wall surface; and
attaching the reverse surface of the sheet to the outwardly facing wall surface of the substrate so that the graphics are visible through the sheet.

21. The method of claim 20, further comprising the step of cutting the polymeric sheet to a desired size before printing graphics to a reverse side of the sheet.

22. The method of claim 21 wherein the polymeric sheet is cut to a size that is substantially coextensive with the desired size of the substrate.

23. The method of claim 20 wherein the graphics are reverse printed by a printing process selected from the group consisting of offset printing, screen printing, flexographic printing and digital printing.

24. The method of claim 20 wherein the reverse surface of the sheet is attached in facing and contacting engagement with the outwardly facing wall surface of the substrate.

25. The method of claim 20 wherein the polymeric sheet is attached to the outwardly facing wall surface of the substrate by applying an adhesive between sheet and substrate.

26. The method of claim 25 wherein the adhesive is applied to the reverse surface of the polymeric sheet after the graphics are reverse printed on the sheet.

27. The method of claim 26 wherein the adhesive is a resin based liquid adhesive.

28. The method of claim 20 wherein the polymeric sheet is laminated to the substrate.

29. The method of claim 20 comprising the additional step of die cutting the substrate.

30. The method of claim 29 wherein the substrate is die cut after attachment of the polymeric sheet.

31. The method of claim 29 comprising the additional step of scoring the substrate.

32. The method of claim 31 wherein the substrate is die cut and scored after attachment of the polymeric sheet.

33. The method of claim 20 wherein the polymeric sheet is substantially coextensive with the outwardly facing wall surface of the substrate.

34. The method of claim 20 wherein the article is a box that is folded and assembled from a die cut and scored substrate.

35. The method of claim 20 wherein the article is a sign.
